(19) United States
(12) Patent Application Publication
(10) Pub. No.: US 2016/0065513 A1
(43) Pub. Date: Mar. 3, 2016

(54) FIGURE OR ICON BASED SYSTEM FOR USER COMMUNICATION

(71) Applicant: Ray Lundy, Bend, OR (US)

(72) Inventor: Ray Lundy, Bend, OR (US)

(21) Appl. No.: 14/632,362

(22) Filed: Feb. 26, 2015

Related U.S. Application Data
(60) Provisional application No. 61/933,226, filed on Jan. 29, 2014.

(51) Int. Cl. H04L 12/58; G06F 3/0484; G06F 3/0488; G06F 3/0482

(52) U.S. Cl. CPC H04L 51/10; G06F 3/0482; G06F 3/04842; G06F 3/0488; H04L 51/043

(57) ABSTRACT

A computer enabled communication system for drafting and sending messages without text between users is provided. The system allows a sending user to compose an image sentence from sequentially chosen images which is communicated over a network to a recipient computing device. A viewing of the composed image sentence by the second user communicates the message from the first user without text or words being required.

This application claims priority to U.S. Provisional Patent Application Ser. No. 61/933,226 filed on Jan. 29, 2014 and incorporated herein in its entirety by this reference thereto.

### BACKGROUND OF THE INVENTION

1. Field of the Invention

The present system relates to human communications using remotely positioned electronic devices. More particularly, the device and method herein disclosed relates to an icon-based or figure-based system of communication which allows users of computing devices with display screens such as smart phones, tablet computers, laptops, and like devices with a display, and capable of digital messaging, to communicate using a set of figures viewable on a display, rather than text.

2. Prior Art

The global market utilizing digital messaging for communication between users of smart phones, tablet computers, and other computing devices having a viewable display screen, has exploded in the last decade. Communication is a basic requirement of most if not every culture, for both business and pleasure, and because of this the employment of digital communication devices with viewable video displays such as smart phones, tablet computers, laptops, computers and the like has expanded into the hands of hundreds of millions of people.

The capability of smart phones and tablet computers to communicate readable data over cellular networks, or via Wi-Fi hotspots, has enabled very inexpensive means for communicating electronically. A result of the lessening of cost from provider competition, and from software allowing users to bypass carriers who charge by the sentence for text communications, has seen the logarithmic increase in both users of text-capable devices and of electronically transmitted digitized messaging around the globe.

Further, as network digital technology moves forward, increased speeds of electronic data paths, such as using 4G or 3G systems, WiFi, and other wired and wireless communications, has augmented the rise in digital communication levels. This has occurred through the provision of a manner to quickly send larger amounts of data, thereby enabling the quick broadcast and receiving of graphic elements with text messages. This has also driven a significant increase in such messaging. Consequently, displayed text messaging, where users send and receive text messages, is now a global phenomenon.

Generally, text based messaging primarily requires the employment of the user's fingers to input letters to form words which are communicated over wired and wireless networks from the sending user to the receiving party. The recipient of one text message may, in turn, answer by inputting the text letters to form words in the same fashion as the original sender. This process repeats millions of times a day between users of such computing devices which include a display for reading text and inputs for sending text.

However, the average vocabulary of an adult person ranges from 35,000 to 60,000 words according to various estimates and each must be input letter by letter onto a digital screen and then sent. For users with impaired vocabularies, or the spelling-challenged, or users with arthritis or other disabilities, or even large fingers, all of which cause trouble for users to touch text keys to input text, creating and sending text messages can be a daunting task. As a consequence, people with physical issues or vocabulary problems draft and send messages which tend to be filled with errors or improper abbreviations all in trying to minimize keystrokes to form a message. Even for users with excellent vocabulary and spelling abilities, a high level of dexterity, and no impairments from disabilities, the duration of time and dexterity required to input a message can be trying.

As such, there exists an unmet need for a viewed digital communication system for communicating meaningful information which is easily discernable by a receiving party for response and which does not require inputting hundreds or thousands of keystrokes to communicate words. Further, such a system should eliminate the need for a user to navigate and accurately hit small text keys on a keyboard or a virtual screen to send messages which are easily misspelled or misunderstood if incorrectly corrected by a spell checker software program.

Still further, such a system should be hierarchical in that a basic set of input keys should provide for quick messaging, and the basic key input for the system should also provide access to subsets of keys relating to the basic input keys, to allow for more detailed non-textual messaging.

The forgoing examples of related art and limitations related therewith are intended to be illustrative and not exclusive, and they do not imply any limitations on the invention and method described and claimed herein. Various limitations of the related art are already or will become apparent to those skilled in the art upon a reading the specification below and the accompanying drawings.

### SUMMARY OF THE INVENTION

The system herein disclosed and described provides users of networked electronic computing devices with video displays, an image-based keyboard, and a communication system for mobile messaging. Employing the available screens using the system herein, the user is afforded a manner to assemble complete and meaningful messages from images without the need for navigating and inputting with a keyboard to send a message composed of text.

In the system herein, the keyboard or other user interface is configured to easily provide quick and efficient access to a large number of images. Employing this easy, quick and efficient access to a very large array of image selections, the system allows the user to compose a message by selecting drawn images, photographs, sound and video clips, and other digital media employable for messaging.

In creating a message, the selected imaging input by the keyboard or other user interface of the system herein is first arranged as an image sentence on a user-viewable display of the user's portable networked computing device. Once composed and depicted to the sending user as the message they wish to communicate, the image sentence may be communicated electronically to the receiving user or amended and sent to the receiving user at the option of the sending user.

The keyboard or input component herein disclosed is provided through the employment of a computer engaged display such as an LED color touch screen of a conventional smart phone or tablet computer, or other touch screen, where a user touches an area of pixels on the display screen to input data to the computing device to process using software running configured for such. In one preferred mode, images are stored in computer memory in a database of such images and software running in computer memory on the device will display, on the video screen thereof, an array of displayed, touch-sensitive images from the stored data.

Optionally, a displayed word or words may be depicted adjacent to each image to provide a quick reference for the images meaning in the event such is unclear to a new user or if the image is newly drawn from the database of images. Beneath the image display area of video display with a touch screen is located three user choice keys including a single alphabet key, an accept key, and a back key.

The provided array of images depicted on the user's screen from those stored in memory of the connected computing device also provides a capability to associate an identifier with a displayed image, which is discernable by the user as leading to a sub-group of related images, for example, a depiction of an image on the video screen having a single color circle surrounding that image. The colored circle indicates a touch of the image therein will allow for navigation to a sub-group of images stored in computer memory. The sub-group may contain provided, user-chosen, or user-input images which the user relates to the primary selection which is encircled. Additionally, the subgroup can contain sounds which can be included in an assembled message which would be played by the receiving computer by touching a sound icon in the assembled image sentence.

As an example, an image of a car having the sub-group identifier. such as a colored circle surrounding it, may. when touched by the user, lead to pictures of a Ford automobile, a Chevrolet automobile, a Ferrari automobile, or other types of automobiles. In use, subsequent to the user touching the display screen on the area pixels depicting the group image having the subgroup identifier, the images in the sub-group will appear on the video screen and replace the array of images originally presented.

In using the display as an input device, such as with a conventional keyboard, a user employs a finger, a wand, or other contact tool to touch the depicted set of images displayed in the area of pixels to contact each image the user wishes to employ to send. Alternatively, the user touches an image having a group image identifier and then touches the video display of sub-group images appearing in a pixel area rendering the sub-group image they wish to employ in the message to be sent. There may be as many sub-groups as the user wishes, and each can include user-input images to depict something or someone the user wishes. For example, in a message between family members, an icon photo of the user's mother, brother, or sister can be included in the subset whereby a message concerning that person can be sent between two users with no misunderstanding about to whom the message or messages communicated relate.

As individual images depicted in respective pixel areas of the screen of the device are touched, each is added to a depiction of a sentence line in an area of the display screen showing the current assembly of the message, and a message viewing area, in an area separate from the image input area on the screen. For example, to send the message, “Driving to the store,” the user can employ the finger or touch tool to contact a car image on the screen, and then an image of a store. The images will appear in the sentence line area in order.

If the sending user finds the assembled image message acceptable, the user can then send the message formed of images in a .jpg or other conventional image file formats. Sounds if sent can be identified to the receiving user by a blank or sound icon in the assembled message which, when touched, will play the sound. Image editing software running on the computing device, engaged with the video screen, can assemble a single image from the multiple images and it may be sent as a single image to another user. The image sent may be a single image, formed by the image editing software on the local device, from the plurality of chosen images which can be sent in an electronic transmission. Alternatively, the software operating the system can assemble the series of images sequentially and hold them in memory and, on transmission of the message, all the images are sent in an identified sequence. Software running the system on the receiving computing device will then assemble the pictorial image for the recipient sequentially and place the image sentence for viewing on the recipient's video display.

To communicate a more detailed message, for example, “I am driving my car to the grocery store,” a photograph of the user's actual car input by the user, with the user driving it, followed by an image of the local Grocery store sign, or an image of the store's sign and name, could be assembled in two images in an image sentence or sequence. As noted, software on the sending computer can assemble the multiple images into one, or software on the receiving computer adapted to the task can assemble the image sentence and display it on the receiving user's device by placing the images in a sequence identified by the software of the sending device. As additionally noted, digital sound files can also be stored in computer memory and employed in an image sentence such as with a blank or sound icon which when touched by the receiving user will play the sound. These can also be customized and uploaded to the memory in their respective devices by individual users.

Further, by using images of people and places known to the sender and recipient, the messages sent are easily understood by family and friends, but essentially gibberish to any person who might encounter the pictorial message who is not familiar with the people, the cars, and the places known to the family and friends. Essentially, secure messages can be sent between users who know the parties' places and things imaged, which will be unknown and indecipherable to persons unfamiliar with them.

During message assembly, or if desired during receipt, beneath the images in the sentence line assembled, may be an area displaying a word associated with each image. As the images are assembled, a rudimentary sentence is built beneath them in the language of the user's choice. Words can be supplied with images or added/changed by the user. The words may be in the language of the user's choice. Further, if a secure message is desired, the words may not relate to the images which are known to the sender and recipient. Thus, someone else who is unfamiliar with the images will decipher the message using words attached which are not the actual message.

The depicted input area or virtual image keyboard of the device may have two other input buttons. These may be located adjacent to the image keys on the screen and the input buttons or pixel areas, when contacted by the user finger or a contact tool, will input accept and/or back functions. The accept key (optionally a plus icon or other user-input image) is employed to allow the software running the system, on the user computing device, to ascertain the user is finished with the message assembly. Once input, the software running on the device and adapted to the task will either assemble the plurality of images to a single image for sending, or may send a plurality of images to the receiving machine, with an identifier of the proper sequence of display on the receiving device display, to make the sentence.

The back key (optionally a minus icon or user input image icon) may be employed to input a signal discerned by the software running the system on the computing device of an incomplete message, and/or to delete the last placed image from the sentence or to back up from a sub-group.

Additionally, in the displayed input area or keyboard of images of the system, a third depicted button on the display screen when touched gives the user the option to link to the standard qwerty text keyboard in the user's language, thereby allowing the user to touch the depicted keys to provide traditional text input. Further, as noted, sounds can be chosen to be sent as part of the sequenced image sentence. The inputted traditional text may be displayed and mixed with the sentence formed of selected images, and any chosen sounds can be sent in the sequence, to send a hybrid message. Of course, the three input buttons may also be mechanical or positioned off the depicted screen of the system.

As can be discerned, the system herein, using a computing device having a processor and electronic memory to run the software in and to store image and sound and other data in, provides a software actuated easily employed application which can be loaded onto computing devices. So loaded into computer memory, the system can employ video displays on such computing devices which are touch screens to assemble and send image-based messages. The system, as can be discerned, can be employed with any language and can be assembled quickly with the depicted media and subgroups. Further, the system can be customized by user-input images and sounds which will also allow users knowing each other, and the parties and places in customized images, to send secure messages which only the sending and receiving users will understand based on their mental memory and discerning of these personalized images and/or sounds formed to a single image or sequence on the receiving computing device, depending on the software operation handling the imaging.

The forgoing examples of related art and limitations related therewith are intended to be illustrative and not exclusive, and they do not imply any limitations on the media messaging system and application described and claimed herein. Various additional limitations of the related art will become apparent to those skilled in the art upon a reading and understanding of the specification below and the accompanying drawings.

### OBJECTS OF THE INVENTION

It is an object of the present invention to provide a system and method which allows users of computing devices having video displays, such as portable computers, smart phones, and other electronic devices employing a touch screen interface for operation, to easily assemble and send picture and sound based messages formed by sequential input of pictures and/or sounds and/or videos on a first device which are sent to a receiving device.

It is an additional object of this invention to provide such a device and method which provides access to large numbers of pictures, media, and sounds through the provision of sub screens accessed easily.

It is an additional object of this invention to provide such a device and method to link images and words.

It is yet another object of this invention to provide a software enabled system for users to send customized image and sound messages which only users familiar with such images and sounds will understand and are therefor self-securing.

These and other objects, features, and advantages of the present invention, as well as the advantages thereof over existing prior art, which will become apparent from the description to follow, are accomplished by the novel improvements described in this specification and hereinafter of the touch screen interface media messaging system as described in the following detailed description which fully discloses the invention, which however in no manner should be considered as placing any limitations thereon.

With respect to the above description, before explaining at least one preferred embodiment of the herein disclosed communication invention in detail, it is to be understood that the invention is not limited in its application to the details of construction and to the arrangement of the components or steps in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other messaging methods and systems for carrying out the several purposes of the present disclosed device. It is important, therefore, that the claims herein be regarded as including such equivalent construction and methodology insofar as they do not depart from the spirit and scope of the present invention.

### BRIEF DESCRIPTION OF DRAWING FIGURES

The accompanying drawings, which are incorporated herein and form a part of the specification, illustrate some, but not the only nor exclusive examples of embodiments and/or components of the disclosed device. It is intended that the embodiments and figures disclosed herein are to be considered illustrative of the invention herein, rather than limiting in any fashion.

In the drawings:

FIG. 1 depicts the system and method herein in an exemplar of the touch screen for assembling pictorial and sound messages employed on a computing device such as a smart phone having a display and touch input.

FIG. 2 shows a recipient computing device such as a smart phone having a display depicting an image sentence communicated from the sending computing device of FIG. 1.

### DETAILED DESCRIPTION OF THE INVENTION

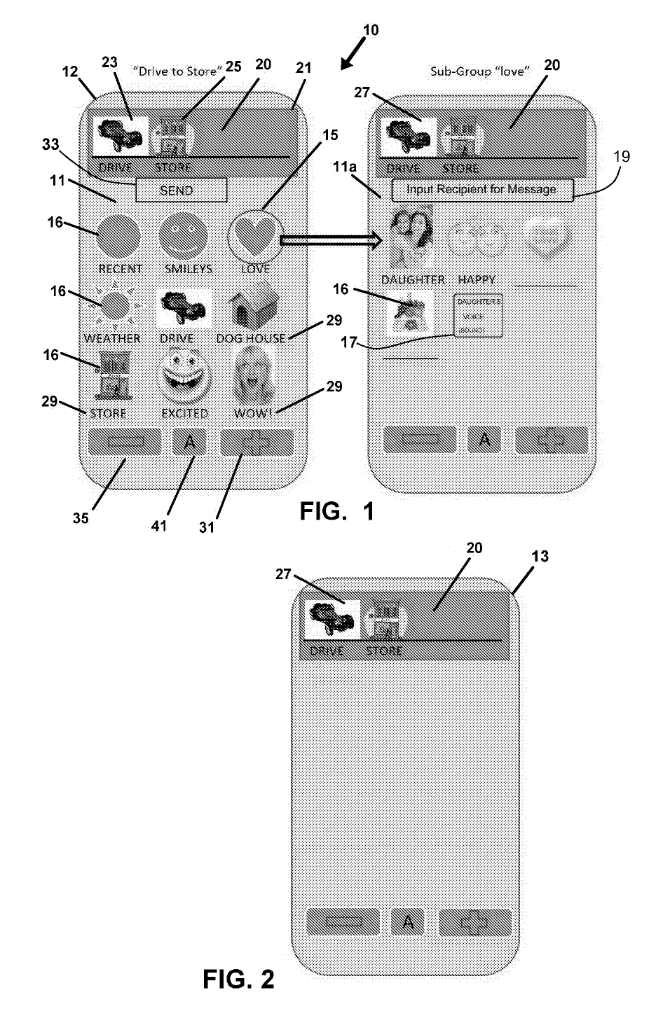

Now referring to drawings, in FIGS. 1-2, wherein similar components are identified by like reference numerals, there is seen in FIG. 1, a depiction of the graphic interface generated by the system 10 herein on a conventional touch screen interface 11 on a video display connected to a computing device. As shown, the touch screen 11 interface such as on a first computing device such as a first user smart phone 12, and a second computing device or receiving computing device (FIG. 2) with a video display such as a second user smart phone 13, which has been designated through an input 19 by text or from a recipient list in computer memory, as the initial recipient of assembled image messages generated upon a first computing device such as the first user smart phone 12.

While the description herein, for a computing device having a network connection and a touch screen video display connected, employs the wording and depiction of a smart phone for convenience, the system 10 may be employed for communication over a network using any computing device having electronic memory for running software and retaining data, and having a network connection, and running the software enabled computer based system 10 herein using a touchscreen 11 interface. Any computer accessible network, be it wired or wireless or combinations thereof, may be employed.

As noted, the system 10 herein employs software running on a computing device having network communications and having electronic memory for running the software and maintaining databases of images and sounds and information, and employs software for inputting, generating, sending, and displaying a picture and sound sentence. Input choices to generate outgoing messages are enabled using a software-generated display on the touch screen 11 interface on a video display operatively connected to the computing device.

The touch screen 11 interfaces are generated as viewable on the display screen of the computing device and places images 16 in pixilated areas of the touch screen 11. A user making contact with respective pixilated areas of an image 16 on the touchscreen 11 interface causes a capacitance, voltage, or other electronically sensed change, related to the individual pixilated area of the touchscreen 11 interface of a chosen depicted image 16 or icon. Conventionally, in all such touchscreen 11 interfaces, this electronically sensed change generates a signal which communicates to the computing device that the pixels in an area of the video display have been chosen and this technology is well known in the art and available and need not be further explained or depicted. It is this contact by the user, with a finger or contact instrument, which provides the signal to the computing device communicated to the software of a choice, of the depicted image 16, in the chosen pixilated area, or, if an identifier 15 is related to the chosen pixilated image 16, a request by the user for the software to cause the video display touchscreen 11 to depict an underlying subset of images or sounds stored in electronic memory in individual pixilated areas which the user may choose from in the same manner.

In operation of the system, the software running thereon is configured to depict images 16 relating to images, other images depicting a related sound 17, or other choices, in individual pixilated areas of the touch screen 11. When these areas of the screen are touched sequentially by a user, a signal is communicated to the computing device and to the software to add the chosen image 16, sound 17, or other choice to the sequence of the message for sending which is depicted concurrently, in the sentence line 20, in an area of the video display touchscreen 11 employed for depicting the assembly of the user message 21.

As shown for example, to send the message, “Driving to the store,” using chosen images 16 and/or sounds 17 in sequence, on the first device 12, the user can employ a finger or touch tool to contact the pixilated image 16 showing a car image 23 on the touchscreen 11, and subsequently touch an image 16 of a store 25. The message formed of these sequential choices and depicted, if approved, can be transmitted using an appropriate approval action, such as contacting a send button 33, generated by the software running the system on the display of the touchscreen 31.

As noted, the sentence image 27, once transmitted, will be depicted on the receiving device 13, may be communicated as a single image formed on the sending device 12 from a plurality of chosen images 16, by imaging software adapted to assemble a single communicable image file, from the sequentially input images 16. However, if the software assembling a single electronic image file from multiple images is too processing intensive for the computing device, the software running the system can send a series of the images 16 and/or sounds 17 chosen by the sending user in a sequence, which will be reassembled on the receiving device 13 and depicted in the communicated sentence image 27 by the display on the receiving device 13. The software assembling a single image from the multiple inputs, or sending multiple sequential images, can also use a proprietary electronic format which can only be opened and displayed by a receiving device 13 having software or a key adapted to open the transmitted file.

As noted, if a larger, or customized vocabulary of pictures and sounds is desired, an identifier 15 adjacent an image 16 can signal the user that touching the image with the identifier 15 will bring up a subgroup screen, 11a wherein images 16 or sound or other media may be chosen for inclusion in the message.

Beneath the image sentence line 27 assembled, and adjacent the images 16, may be a text area displaying a word 29 associated with each image 16. As the images are assembled, a rudimentary sentence may be built beneath them in the language of the user's choice. The words 29 can be supplied with the images 16 or added/changed by the user in a language of user's choice.

The touch screen 11 may have two input buttons beneath the image 16 keys which when contacted by the user finger or tool, will provide accept and/or back functions. The accept key 31 (optionally a plus icon) may be employed to input more images 16 for the message, or send it if hit twice for instance, or a send key 33 may be employed for sending the approved message. The back key 35 (optionally a minus icon) may be employed to delete the last placed image 16 in the depicted sentence line 20 or to return from subgroup screen 11a to the start screen 11.

Additionally provided in the generated touchscreen 11 of the system 10, a third depicted button 41 input choice links to the standard text keyboard in the user's language, and adjusts the software assembling the message to allow and receive traditional text input.

As can be discerned, the system 10 herein provides an easily employed application which will operate on computing devices which employ touch screens 11 to assemble and send image based messages which can be employed with any language and can be assembled quickly with the depicted media and subgroups 11a.

As noted above, the system 10 can be customized by allowing users to input user images 16 and sounds 17 to customize their messages. Any electronic photo file or audio file can be uploaded into the computing device running the software which will be configured to accept user inputs and convert them to respective chooseable images 16 or sounds 17 and will store them in the converted format in computer memory with the other images 16 and sounds 17. Such an option is especially preferred as it allows users, who know each other or are related, to upload customized images 16 and sounds 17 which they will immediately recognize such as a picture 16 of a family member or a sound 17 of a relative's voice which is recognizable to family members or friends.

When a message is assembled using these customized and personal images 16 and sounds 17, it will be quickly discerned due to mutual familiarity with the images 16 and sounds 17. Further, the message can be secure by using personal images 16 and sounds 17 which will be recognized and understood by relatives or good friends, but will be unintelligible to others who will not have the human memory ability to recognize the picture 16 or sound 17 in any context which would make sense.

Additionally, the system 10 herein, can operate using appropriate software on a cloud or server as the computing device using a software application loaded upon the local computing devices of the sending user and receiving user, which is adapted to communicate with the system provider cloud or server. Thus, users can have accounts and store personalized images 16, sounds 17, and the like into computer memory connected to the server of the system provider and have their respective displayed and chosen images 16 and/or sounds 17 on their touch screens 11 generated by the software on the server and received and transmitted from sending users to receiving users through communications with the system provider server or computing devices. Such will lower the computing necessary locally, and electronic memory requirements locally, because the majority of software processing to form and send messages, and to store images and sounds, will be handled by the provider server and computing devices and electronic memory.

As previously noted, any of the different configurations of computing devices, components, and touch screens may be employed with any other configuration, component, or touchscreen shown and described in the system herein. Additionally, while the present system as an invention has been described herein with reference to particular modes or embodiments thereof and steps in the method of production, a latitude of modifications, various changes, and substitutions are intended in the foregoing disclosures. It will be appreciated that in some instances some components, screens, or configurations, steps in formation, and/or use of the invention could be employed, without a corresponding use of other components, screens, or configurations, without departing from the scope of the invention as set forth in the following claims. All such changes, alternations, and modifications, as would occur to those skilled in the art upon reading this disclosure, are considered to be within the scope of system as broadly defined in the appended claims.

Further, the purpose of any abstract of this specification is to enable the U.S. Patent and Trademark Office, the public generally, and especially the scientists, engineers, and practitioners in the art, who are not familiar with patent or legal terms or phraseology, to determine quickly, from a cursory inspection, the nature and essence of the technical disclosure of the application. Any such abstract is neither intended to define the invention of the application, which is measured by the claims, nor is it intended to be limiting as to the scope of the invention in any way.

What is claimed is:

1. A computer enabled communication system comprising:
a computing device having electronic memory and network communications;
video-depicting software running on said computing device and configured to depict a plurality of individual images stored in said electronic memory, in individual positions upon a video display of a first user;
said video display of said first user configured to communicate a signal to said computing device relating each specific said individual image chosen by said first user through touching respective said individual positions of said video display relating thereto in a sequence;
imaging software running on said computing device configured to receive from said computing device each said signal relating to an individual said image in said sequence, and to depict an image message including all said plurality of said images chosen in said sequence in which they were chosen;
a first input area depicted on said video display for said first user to input a recipient for said image message for communication software running on said computer;
a second input area depicted on said video display for said user to touch and signal acceptance of said image message, whereby said image message is communicated by said communication software over a network to a recipient computing device having a video display; and
imaging software running on said recipient computing device configured to depict said image message upon said video display of said recipient computing device, whereby messages between said first user and said recipient can be communicated without employing words or text.

2. The computer enabled communication system of claim 1, wherein software configured to access said electronic memory is configured for input by a said first user, of user-generated said images for storage in said electronic memory.

3. The computer enabled communication system of claim 1, wherein said plurality of individual depicted in individual positions upon a video display of said first user include audio images relating to audio files stored in said electronic memory and said image message communicated includes a said audio file.

4. The computer enabled communication system of claim 1, wherein said imaging software running on said computing device is configured to receive from said computing device each said signal relating to an individual said image in said sequence, and to generate an image message including all said plurality of said images chosen in said sequence in which they were chosen, as a single image file, from said plurality of images chosen, whereby said image message is communicated by said communication software, as a single image file containing said image message, to said recipient computing device over said network.

5. A method for sending messages from a sending computing device of a first user having electronic memory and a network communication component, to a recipient computing device of a second user having electronic memory and a network communication component, comprising:
running video-depicting software on said sending computing device configured to depict a plurality of individual images stored in said electronic memory of said sending computing device, in individual positions upon a video display connected to said sending computing device;
configuring said video display of said sending computing device to communicate a signal to said sending computing device relating to each specific said individual image chosen by said first user by touching respective said individual positions of said video display, relating to a respective said image, in a sequence;
employing software running on said sending computing device configured to receive said signals from said sending computing device relating to each individual said image chosen by said first user in said sequence, and to depict an image message including said plurality of said images depicted adjacent and in said sequence in which they were chosen;
providing a first input area depiction on said video display of said sending computing device for said first user to input said recipient for said image message;
positioning a second input area depiction on said video display of said sending computing device for said first user to touch to signal acceptance of said image message;
subsequent to a receipt by said sending computing device of said signal of acceptance, communicating said image message over said network to said recipient computing device; and
employing imaging software running on said recipient computing device to depict said image message upon said video display of said recipient computing device, whereby messages between said first user and said second user can be communicated without employing words or text.

6. The method for sending messages of claim 5 additionally including:
employing software running on said sending computing device configured to receive said signals from said sending computing device relating to each individual said image chosen by said first user in said sequence, to form an electronic file of a single image depicting said image message including said plurality of said images depicted adjacent and in said sequence in which they were chosen; and
communicating said image message over said network to said recipient computing device as said electronic file as of a single image.
